(19) United States
(12) Patent Application Publication
(10) Pub. No.: US 2024/0051111 A1
(43) Pub. Date: Feb. 15, 2024

(54) Firefighter Hook Tool

(71) Applicant: Orlando Santana, Rahway, NJ (US)

(72) Inventor: Orlando Santana, Rahway, NJ (US)

(21) Appl. No.: 17/887,737

(22) Filed: Aug. 15, 2022

(51) Int. Cl. B25G 1/04; B25F 1/02

(52) U.S. Cl. CPC B25G 1/04; B25F 1/02

(57) ABSTRACT

An article of manufacture for providing an extendable firefighter hook tool according to the present invention includes an extending pole member having a top end and a first middle end, a base pole member having a second middle end and a bottom end, an extension lock coupling the first middle end to the second middle end, and a replaceable tip coupled to the top end, the replaceable tip comprises a drywall hook, a New York hook, and a pike pole

### TECHNICAL FIELD

This application relates in general to an article of manufacture for providing a firefighting device, and more specifically, to an article of manufacture providing an extendable firefighter hook tool.

### BACKGROUND

Currently, firefighters use a tool that is called a “hook or pike pole” that comes in multiple sizes. The sizes range from 6 ft 8 ft, and 10 ft. These hooks/pike poles are used to pull ceilings, break windows, break walls, etc. Once a size hook is chosen and brought into a burning building, however, the firefighter is typically stuck with it. Experienced firefighters specifically noticed an issue in the fire service that appears to be ongoing. At emergencies the actual seat of the fire, the personnel notice that the 6-foot hook the most frequently used tool that is initially pulled is too short to reach the 15-foot ceilings in the uniquely built structure. The firefighters have to re-group and formulate a different strategy to get the proper tool/hook to the location by either calling for more units with specific details of required tools have to go back to the apparatus to switch tools when low of available manpower. In order to successfully put out the fire, strategies in the tail of a coordinated attack between truck and engine companies of the fire service. The truck company pulls/breaks ceilings while engine companies use hose lines to put water on the fire. In some situations, the walk back through a hectic fireground can be tedious, dangerous, and time-consuming. With that being stated, it will explain the importance of having the right tool for the job at any given moment. In the fire service, time is of the essence; a life may depend on it.

Therefore, a need exists for an article of manufacture providing an extendable firefighter hook tool. The present invention attempts to address the limitations and deficiencies in prior solutions according to the principles and example embodiments disclosed herein.

### SUMMARY

In accordance with the present invention, the above and other problems are solved by providing an article of manufacture for an extendable firefighter hook tool according to the principles and example embodiments disclosed herein.

In one embodiment, the present invention is an article of manufacture providing an extendable firefighter hook tool. The extendable firefighter hook tool includes an extending pole member having a top end and a first middle end, a base pole member having a second middle end and a bottom end, an extension lock coupling the first middle end to the second middle end, a replaceable tip coupled to the top end using a first threaded coupling, and a bottom tool coupled to the bottom end using a second threaded coupling. The bottom tool comprises a rubbish/Roof hook, a D-Handle hook, and a Gas Shut-off hook. The extension lock comprises one or more depressible locking pegs extending outward from the extending pole member and through one of a plurality of extension coupling holes to hold the base pole member and extending pole member in a position relative to each other. The replaceable tip comprises a drywall hook, a New York hook, and a pike pole.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates example embodiments of an article of manufacture providing an extendable firefighter hook tool according to the present invention.

FIG. 2 illustrates an extension of an article of manufacture providing an extendable firefighter hook tool according to the present invention.

FIG. 3 illustrates an extension adjustment mechanism useful for an article of manufacture providing an extendable firefighter hook tool according to the present invention.

FIGS. 4a-b illustrate a handle of an article of manufacture providing an extendable firefighter hook tool according to the present invention.

FIGS. 5a-c illustrate an example embodiment for a hook tool for attachment to an extendable firefighter hook tool according to the present invention.

FIGS. 6a-d illustrate an example embodiment for a second tool for attachment to an extendable firefighter hook tool according to the present invention.

### DETAILED DESCRIPTION

This application relates in general to an article of manufacture for providing a firefighting device, and more specifically, to an article of manufacture providing an extendable firefighter hook tool according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context dictates otherwise. As used herein, a plurality of items, structural elements, compositional elements, and/or materials may be presented in a common list for convenience. However, these lists should be construed as though each member of the list is individually identified as a separate and unique member. Thus, no individual member of such a list should be construed as a de facto equivalent of any other member of the same list solely based on their presentation in a common group without indications to the contrary. As used herein, the singular forms “a,” “an,” and “the” are intended to include the plural forms as well, unless the context indicates otherwise.

It further will be understood that the terms “comprises,” “comprising,” “includes,” and “including” specify the presence of stated features, steps, or components, but do not preclude the presence or addition of one or more other features, steps or components. It also should be noted that in some alternative implementations, the functions and acts noted may occur out of the order noted in the figures. For example, two figures shown in succession may be executed substantially concurrently or may sometimes be executed in the reverse order, depending upon the functionality and acts involved.

The terms “individual” and “user” refer to an entity, e.g., a human, using an article of manufacture providing an extendable firefighter hook tool according to the present invention. The term user herein refers to one or more users.

The term “invention” or “present invention” refers to the invention being applied via the patent application with the title “A Firefighter Hook Tool.” The invention may be used interchangeably with the hook tool.

In general, the present disclosure relates to an article of manufacture providing an extendable firefighter hook tool according to the present invention. With a new and improved hook, the firefighter will be able to not only stay and perform the pulling/breaking necessary for the job but also will continue to be an asset to the surrounding members while saving time and effort. The “Santana Hook” is primarily a truck company tool that would be used for various tasks. Pulling and breaking interior walls during a fire is one of the multiple features of the tool.

The standard fire service hook is used in various ways but is very limited, unfortunately. Unlike the “Santana Hook” 100 one cannot adjust the actual sizing of the hook from 4-10 feet in height. There is only a variation of 6-foot, 8-foot, and 10-foot hooks. An 8-foot and the 10-foot poles/hooks needs to be operated in tight areas where a lot of firefighters may be performing different tasks. This movement may be rather difficult to maneuver the tool to get the job started. With the “Santana hook” 100, a fire fighter is able to easily maneuver the tool into position by keeping it at its starting point of 4 foot and once in the desired position, fully extend the tool upward to reach and perform the tasks without the chance of injury nearby.

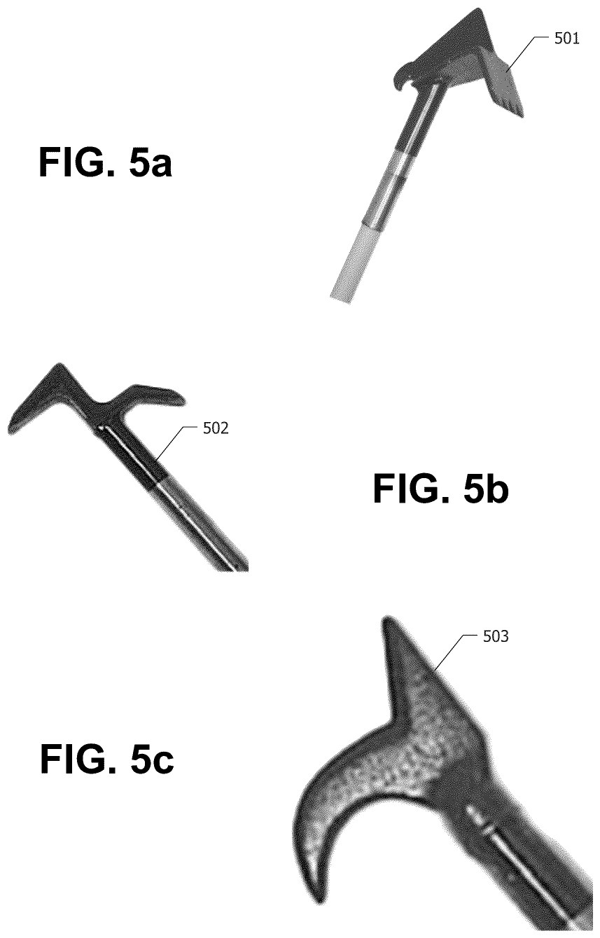

Also, the standard fire hook does not have the option of interchanging the types of ends/heads for the desired tasks. In regular cases, the firefighter has to change the actual hook tool to meet the requirements for the situation. When a standard hook entering a structure with a regular “New York Roof Hook” head, as shown Figure-5B, and the hook is not able to poke through as promptly due to the structure's tin ceilings that were never removed from the 1950s. A firefighter's job becomes more tedious when this situation presents itself as the task becomes a longer process to get the proper ventilation to extinguish the fire. This situation could be addressed using a standard hook best used for tin ceilings as shown in FIG. 5A herein.

The “Santana Hook” 100 according to the present invention provides the most used tips/heads used for today's jobs by simply twisting counterclockwise. This action is similar to changing a broom head from a broomstick. Each end of the pole 102-103 is threaded so tip/heads can be inserted and rotated clockwise to fasten and secure the actual part being attached. No matter how much pulling or prying tip/head would be unremovable unless safely rotated counterclockwise by the operator.

Another of many dangers for firefighters occurs when overhead obstructions, primarily utility wires, may be rather life-threatening when getting on or off the roof of the structure from the ariel ladder attached to the apparatus. Although frowned upon, sometimes the only way to get to the roof of a structure fire is to get somewhat close to the electrical utility lines placed closely to the structures. Any type of interaction with these wires is life-threatening due to the high voltage amps. As mentioned, the standard hook sizes can be uneasy to maneuver going up and down an ariel while being mindful of overhead obstructions. The “Santana Hook” 100 of the present invention is easier to break down in size “4 feet” to lessen the risk of coming encountering life-threatening dilemmas. Firefighters bring a hook to the roof for multiple purposes, especially because the hook is the firefighter's best tool for life safety.

Once a firefighter has gotten to the edge of the roof and is still on the ariel there is a method called “sounding the roof”. This is when the firefighters use the hook that is at the tip of the ariel, typically a 6-foot hook, to forcefully bang the end of the tool against to roof to check for roof conditions especially when visibility is low. This action is mainly used to check whether the roof has not been compromised so much where that the roof will not support the weight of the firefighters. At times this action can be a risky task if the structure has a parapet wall hoovering above the actual roof line. In this case, a 6-foot hook provided at the tip of the ariel will not have the adequate length to be able to perform the sounding of the roof. With the “Santana Hook” 100, personnel would be able to extend the hook up to 10 feet from the safety of the ariel device before even jeopardizing their lives on a spongy roof that may collapse if noticeably weakened.

On roofs with low visibility, the hook can be used as a “White Cane” like used by the blind. A firefighter may use a method of pushing the hook out in front of him/herself to ensure themselves of any trip hazards or unseen holes they can fall through or even the edge of the roof line where one could completely walk off resulting in death or serious injury. With the ability to extend a hook 10 feet in front of themselves, it lessens the chances of any of the hazards mentioned. Firefighters working with an extra 4 feet of awareness as to what is in from of him/her are given additional time to react.

Additionally, truck company members must vent roofs in order to ventilate the fire properly to get the job done when ordered in the given situation. Once firefighters vent a 4′×4′ hole over the main body of the fire using a circular saw, they must punch a hole through the existing ceiling line which lies below the cut made by the saw to introduce fresh air and vent the fire from the highest point in the structure. As mentioned, the only hook provided to complete this task is the hook at the end of the arial which is normally a 6-foot hook. In some cases, the 6-foot hook is not sufficient to push through the hole made by the saw team. “Santana Hook” 100 eliminates that problem by being able to extend to the size desired in order to get the job done in a timely fashion.

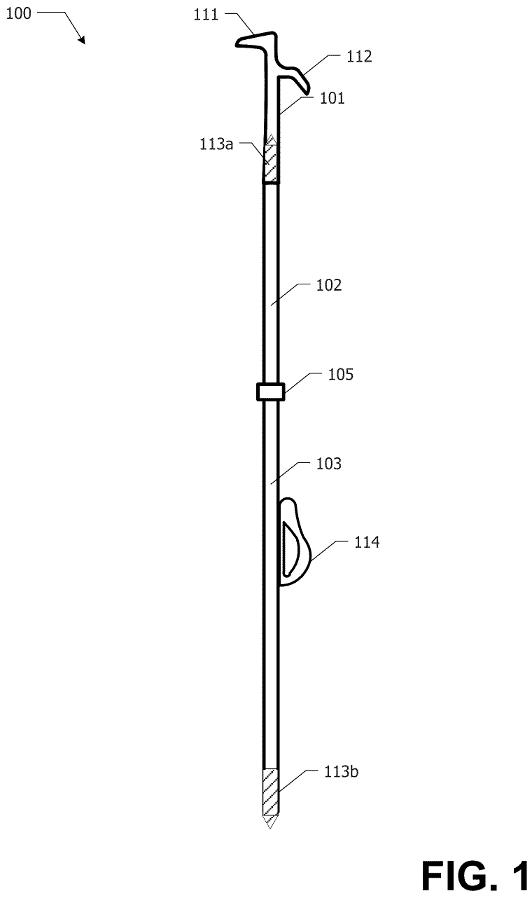

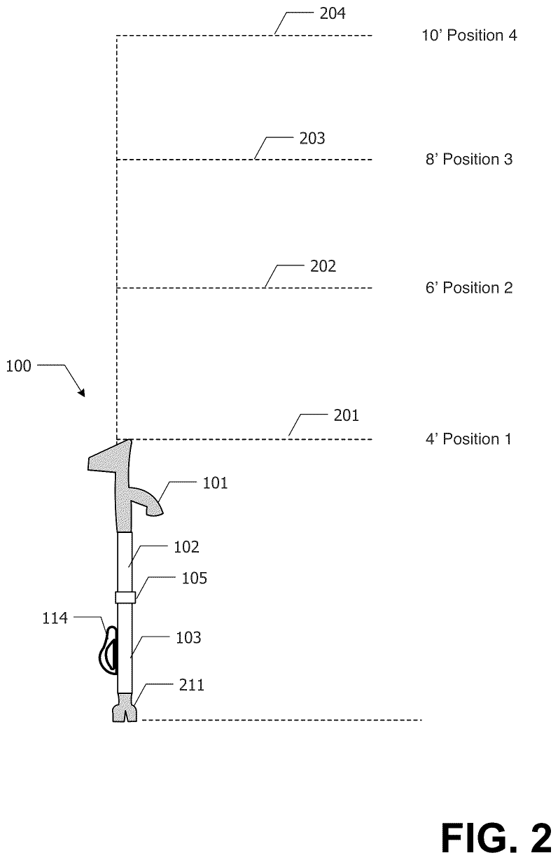

For additional details, FIG. 1 illustrates example embodiments of an article of manufacture providing an extendable firefighter hook tool according to the present invention. By designing the “Santana Hook” 100, the present invention eliminates the guessing game when it comes to which size hook tool 100 will be needed for the job before entering the fire building. The hook tool 100 would have a similar design as a regular fire service hook/pike pole, but the difference would be the options that would be at your fingertips for the situation, The “Santana Hook” 100 would start as a 4′ hook primarily for any job on the fireground that would require space to move. Then once the firefighter is at the desired location, he/she would be able to adjust the tool from 4′, to 6′, to 8′ and even to 10′ as shown in FIG. 2, as needed for a particular occurrence. It wouldn't matter how tall the ceiling, how low dangerous electrical wires could be, how deep the hole is so the firelighter can punch a hole through to let the fire vent. etc. There is a long list of actions that can be taken using the “Santana Hook” 100 on the fireground. The hook tool 100 also would be equipped with replaceable tips 101 and attachments for specific tasks that would help cut the time in half when it comes to preserving property and most importantly, saving lives.

The hook tool 100 comprises a replaceable tip 101, an extending pole member 102, a base pole member 103, and an extension lock 105. The replaceable tip 101 in a preferred embodiment provides a first hook 111 on one side of the extending pole member 102 and a second 112 on an opposite side of the extending pole member 102. The extending pole member 102 and the base pole member 103 may be made of fiberglass in a preferred embodiment to prevent these members from conducting electricity when contacting active electric wires when used. The extending pole member 102 extends out of the base pole member 103 in a telescoping configuration.

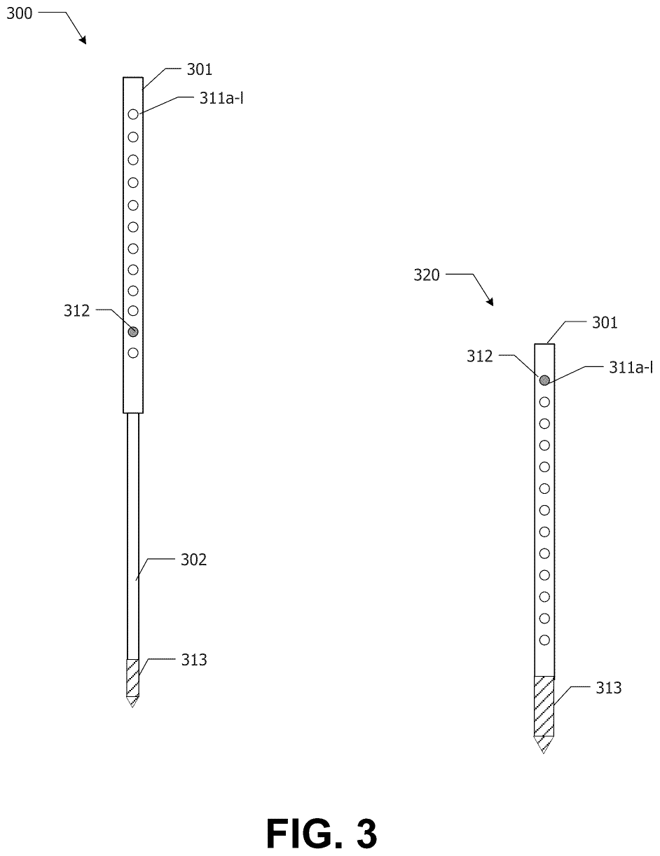

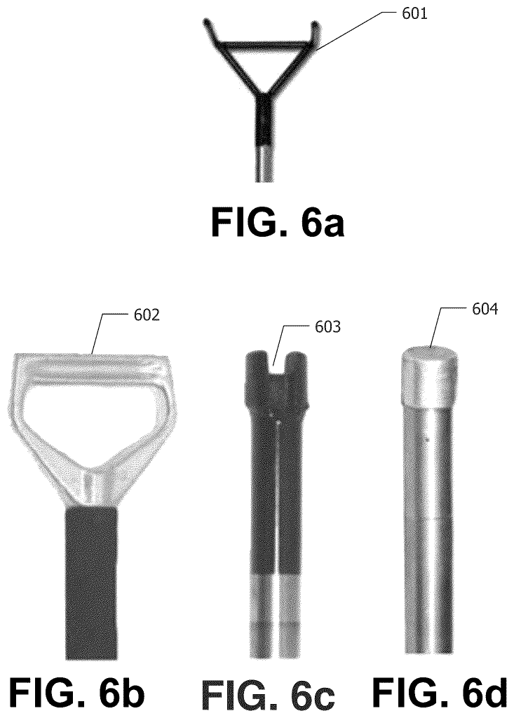

The extending pole member 102 may comprise a single extending member or may comprise multiple telescoping pole members. The extending pole member 102 is locked in place relative to the base pole member 103 by the extension lock 105. For an extending pole member 102 having multiple telescoping components, a separate extension lock (not shown) may be utilized at each extending pole member. As disclosed below in reference to FIGS. 5a-c and FIGS. 6a-d, the tools are coupled to the pole members 102-103 with threaded ends 113a-b being inserted and rotated in threaded mating holes in each tool. The extension lock 105 is a user-engaged coupling mechanism disclosed below in reference to FIG. 3.

FIG. 2 illustrates an extension of an article of manufacture providing an extendable firefighter hook tool according to the present invention. The hook tool 100 is shown with the replaceable tip 101 coupled to the extending pole member 102 coupled within the base pole member 103 at its shortest length, a length corresponding to position1 201 at a 4′ length. The extending pole member 102 may be extended out of the base pole member 103 until the hook tool 100 is positioned at position 2 202 having a total length of 6 feet, position 3 203 having a total length of 8 feet, and position 4 204 having a total length of 10 feet. The firefighter may adjust the hook tool 100 between position 1 201 and position 4 204 by disengaging the extension lock 105, extending the extending pole member 102 to a desired position 201-204, and re-engaging the extending lock 105. The firefighter may adjust the hook tool 100 as often as needed without changing a location within the fireground.

FIG. 3 illustrates an extension adjustment mechanism useful for an article of manufacture providing an extendable firefighter hook tool according to the present invention. One possible extension lock 105 is shown in FIG. 3. The extending pole member 302 is shown in a fully extended configuration 300 and at a fully collapsed configuration 320. In this particular embodiment, the extending pole member 102 extends out of the bottom of a base pole member 301. In other embodiments, the extending pole member 302 may extend upward from the base pole member 301.

In this particular embodiment of FIG. 3, the base pole member 302 comprises a plurality of extension coupling holes 311a-1 running vertically along with the base pole member 302. One or more depressible locking pegs 312 extend outward from the extending pole member 301 and through one of the plurality of extension coupling holes 311a-1 to hold the base pole member 302 and extending pole member 301 in a position relative to each other. With the depressible locking pegs 312 coupled to the extending pole member 302 within the base pole member 302, depression of the depressible locking peg 312 permits the inner extending pole member 301 to move within the base pole member 301. Once in a desired length, the depressible locking peg 312 is released to engage a different one of the plurality of extension coupling holes 311a-1 locking the hook tool 100 at a new length. In this embodiment, the replaceable tip 101 is coupled to the upper end of the base pole member 302. In an embodiment in which the extending pole member 301 extends upward from the base pole member 302, the replaceable tip 101 is coupled to an upper end of the extending pole member 301. Threaded ends 313a-b to an end of the base pole member 302 and an end of the extending pole member 301 are used to couple the various hooks onto the pole members 301-302.

As noted above, an extension lock 105 may be used for coupling each segment of a multi-segment extending pole member using a similar mechanism at each coupling. Such an arrangement may allow the length of the hook tool 100 to be adjusted at each of the one or more multi-segment extending pole member coupling points in a similar fashion.

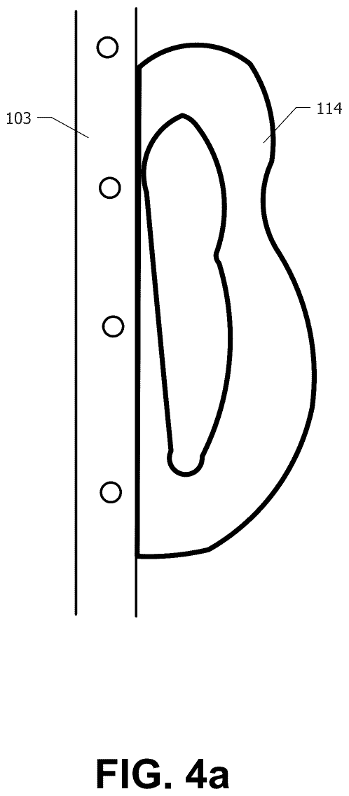

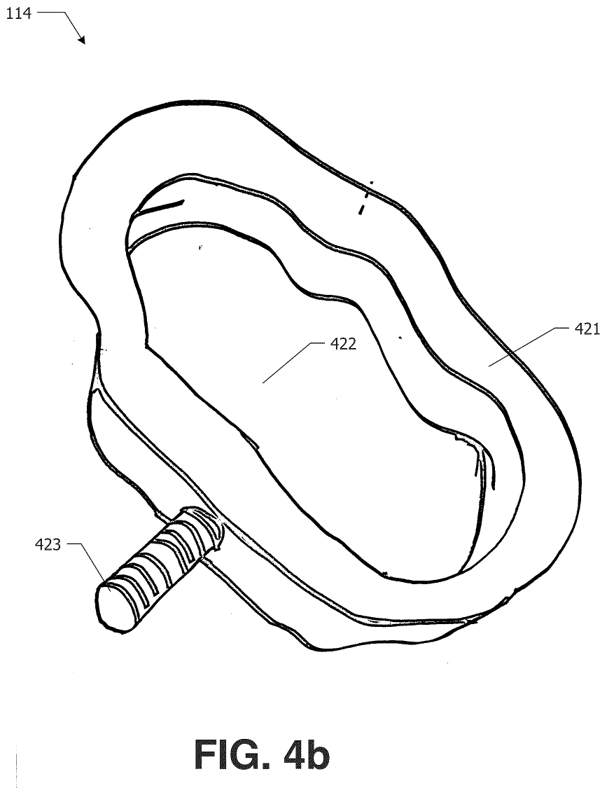

FIGS. 4a-b illustrate a handle of an article of manufacture providing an extendable firefighter hook tool according to the present invention. FIG. 4a shows a handle 114 coupled to the base pole member 103. The handle 114 provides a firefighter with a mechanism to obtain and maintain a firm grip upon the hook tool 100 when in use while wearing protective gear.

FIG. 4b shows a close-up view of the handle 114 which comprises a handle body element 421, a gripping hole 422 within a center portion of the handle 114, and a threaded attachment member 423 used to couple the handle 114 to the base pole member 103. The handle body element 421 has a flat edge on one side onto which the threaded attachment member 423 is attached. An opposing side of the handle body element 421 curves outward from the base pole member 103 to surround a portion of a hand while gripping the handle body element 421 and/or the base pole member 103. The gripping hole 422 provides an opening within the handle 114 into which a firefighter inserts a hand when in use. The threaded attachment member 423 coupled to a threaded hole (not shown) in the base pole member 103. The threaded attachment member 423 typically couples to the base pole member 103 below a point into which the extending pole member 102 and the base pole member 103 overlaps when the hook tool 100 is configured in a compact configuration so as not to conflict with the extension lock 105 and the plurality of extension coupling holes 311a-1.

FIGS. 5a-c illustrate an example embodiment for a hook tool for attachment to an extendable firefighter hook tool according to the present invention. Similarly, FIGS. 6a-d illustrate an example embodiment for a second tool for attachment to an extendable firefighter hook tool according to the present invention. These other hook tools and devices may include the various tools illustrated in FIGS. 5a-c disclosed below. Each example of a hook tool 501-503 of FIGS. 5a-c may be coupled to a first end of the extending pole member 302. In a preferred embodiment, each of these hook tools 502-503 may couple to the extending pole member 302 using a threaded pole end 113a-b being inserted and rotated within a threaded vertical shaft hole within each hook tool 501-503. The hook tools 501-503 are typically referred to as a “drywall hook” 501, a “New York hook” 502, and a “pike pole” 503. Other coupling mechanisms may be used, for example, a friction joint between the extending pole member 302 and a vertical shaft hole within each hook tool 501-503 and an end tool extension lock similar to the extension lock used to set the length of the extending pole member 302.

Other tools and devices may be placed at a bottom end of the base pole member 113b, for example, a pry bar as shown in FIG. 2 at the bottom of the hook tool 100. Other base pole tools 601-604 and devices may include the various tools illustrated in FIGS. 6a-d disclosed below. Each example of a base pole tools 601-604 of FIGS. 6a-d may be coupled to a first end 113a of the base pole member 301. FIG. 6a shows a “rubbish/Roof hook” 601. FIG. 6b shows a “D-Handle hook” 602. FIG. 6c shows a “Gas Shut-off hook” 603. FIG. 6d shows a “ram knob hook” 604.

In a preferred embodiment, each of these base pole tools 601-604 may couple to the base pole member 301 using a threaded pole 113b being inserted and rotated within a threaded vertical shaft hole within each hook tool 601-604. Other coupling mechanisms may be used, for example, a friction joint between the base pole member 301 and a vertical shaft hole within each hook tool 601-604 and an end tool extension lock similar to the extension lock used to set the length of the extending pole member 302.

Other locking mechanisms may be utilized by the extension lock 405 that securely couples the base pole member 402 to the extending pole member 401 at a particular position that defines the length of the hook tool 400. The extension lock 405 provides sufficient retention force to hold the base pole member 402 to the extending pole member 401 at the particular position while being easily disengaged by a firefighter when needed to permit the hook tool 400 to be adjusted before securely re-engaging at a new position. For each hook tool 501-503 and each hook tool 601-604 are shown in a female configuration that accepts a male configuration of the base pole member 302 and the extending pole member 301, in alternate embodiments, the configurations may be reversed with the threaded end of each tool end is inserted into a threaded hole in the base pole member 202 and the extending pole member 301.

Even though particular combinations of features are recited in the present application, these combinations are not intended to limit the disclosure of the invention. Many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An extendable firefighter hook tool comprises:
an extending pole member having a top end and a first middle end;
a base pole member having a second middle end and a bottom end;
an extension lock coupling the first middle end to the second middle end; and
a replaceable tip coupled to the top end, the replaceable tip comprises a drywall hook, a New York hook, and a pike pole.

2. The extendable firefighter hook tool according to claim 1, wherein the extending pole member and the base pole member are made of fiberglass.

3. The extendable firefighter hook tool according to claim 1, wherein the replaceable tip coupled to the top end using a friction coupling

4. The extendable firefighter hook tool according to claim 1, wherein the replaceable tip coupled to the top end using a threaded coupling.

5. The extendable firefighter hook tool according to claim 1, wherein a combined length of the extending pole member and the base pole member is adjustable between 4 feet and 10 feet.

6. The extendable firefighter hook tool according to claim 5, wherein the extension lock comprises one or more depressible locking pegs extending outward from the extending pole member and through one of a plurality of extension coupling holes to hold the base pole member and extending pole member in a position relative to each other.

7. The extendable firefighter hook tool according to claim 1, wherein the extendable firefighter hook tool further comprises a bottom tool coupled to the bottom end, the bottom tool comprises a rubbish/Roof hook, a D-Handle hook, and a Gas Shut-off hook.

8. An extendable firefighter hook tool comprises:
an extending pole member having a top end and a first middle end;
a base pole member having a second middle end and a bottom end;
an extension lock coupling the first middle end to the second middle end, the extension lock comprises one or more depressible locking pegs extending outward from the extending pole member and through one of a plurality of extension coupling holes to hold the base pole member and extending pole member in a position relative to each other;
a replaceable tip coupled to the top end using a first threaded coupling, the replaceable tip comprises a drywall hook, a New York hook, and a pike pole; and
a bottom tool coupled to the bottom end using a second threaded coupling, the bottom tool comprises a rubbish/Roof hook, a D-Handle hook, and a Gas Shut-off hook.
wherein the extending pole member and the base pole member are made of fiberglass; and
a combined length of the extending pole member and the base pole member is adjustable between 4 feet and 10 feet.
